(19) United States
(12) Patent Application Publication
(10) Pub. No.: US 2008/0300967 A1
(43) Pub. Date: Dec. 4, 2008

(54) Interactive Marketing, Product/Market Research, Contact Access and Usage Tracking for Wireless

(76) Inventors: David John Buckley, Jamul, CA (US); Mark Joseph Munoz, La Jolla, CA (US)

Correspondence Address: GORDON E NELSON;PATENT ATTORNEY, PC, 57 CENTRAL ST, PO BOX 782, ROWLEY, MA, 01969, US

(21) Appl. No.: 12/132,235

(22) Filed: Jun. 3, 2008

Related U.S. Application Data
(60) Provisional application No. 60/941,817, filed on Jun. 4, 2007.

(51) Int. Cl. G06Q 30/00

(52) U.S. Cl. 705/10; 705/14

(57) ABSTRACT

A method and system for requesting and delivering mobile marketing interactions, controlling access and tracking usage for wireless device applications directly from a wireless device is disclosed. Upon starting an application on a wireless device, the application connects to a server and posts information about the application, the user of the application, device specific data and any cached marketing interactions. This information is processed by the server. Application usage statistics, marketing interactions and any device changes are stored in a database at the server. Real-time processing and business rule checks on the information sent from the wireless device application is performed by the server to determine content access rights by the user as well as current marketing interactions that will be displayed within the application. Content access rights and marketing information is returned to the wireless device application from the server which configures the current user experience of the wireless device application.

### CROSS-REFERENCE TO RELATED APPLICATIONS

This application claims priority to co-pending U.S. provisional patent application entitled “Interactive Advertising and Product/Market Research for Wireless Device Applications”, Ser. No. 60/941,817, filed on Jun. 4, 2007.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

1. Field of the Invention

The invention relates to wireless devices, and more particularly, to the handling and rendering of both interactive and non-interactive marketing interactions within applications on wireless devices, and to the complete control of the user experience.

2. Description of Related Art

Wireless devices (cell phones, PDAs, smart phones) are mini computers and capable of running both a web browser as well as full applications that have rich user interfaces. Mass market cell phones make use of BREW, Java, Symbian, Windows or newer operating systems such as Linux, OHA and others to enable applications to be created and executed on the device. Most wireless devices in the market today are also capable of connecting to the Internet via a cellular connection, WiFi or other wireless technology. With its ability to connect to a network, a mobile device is now capable of connecting to a server on the network.

There are over 200 million cell phones in the US market and the owners of these phones carry it with them most places they go. This personal device with its user interface makes it an attractive screen for marketers to deliver advertisements and other forms of marketing to people wherever they are.

Advertisements on cell phones or any wireless device is both a pot of gold and a potential hornet's nest for companies in the mobile advertising value chain. It has the potential for one-to-one marketing with each consumer, but also the ability to alienate the consumer by being seen as spam.

Thus, what is needed is a method and system for delivering rich, user interactive, non-intrusive, relevant marketing to consumers on wireless devices.

### BRIEF SUMMARY OF THE INVENTION

A method and system for requesting and delivering mobile marketing interactions, controlling access and tracking usage for wireless device applications directly from a wireless device is disclosed. Upon starting an application on a wireless device, the application connects to a server and posts information about the application, the user of the application, device specific data and any cached marketing interactions. This information is processed by the server. Application usage statistics, marketing interactions and any device changes are stored in a database at the server. Real-time processing and business rule checks on the information sent from the wireless device application is performed by the server to determine content access rights by the user as well as current marketing interactions that will be displayed within the application. Content access rights and marketing information is returned to the wireless device application from the server which configures the current user experience of the wireless device application.

### BRIEF DESCRIPTION OF THE SEVERAL VIEWS OF THE DRAWINGS

FIG. 1 illustrates an embodiment of a system for delivering marketing interactions, restricting access and tracking usage of wireless device applications directly on a wireless device.

FIG. 2 illustrates an embodiment of a platform for the delivering of marketing interactions.

FIGS. 3A-3E illustrate example consumer experiences of the inventive deliverance of marking interactions.

FIG. 4 is a flowchart illustrating an embodiment of a method for requesting marketing interactions, application access and usage tracking for wireless device applications directly from a wireless device.

FIG. 5 is a flowchart illustrating an embodiment of a method for receiving marketing interactions, application access by wireless device applications directly from a server.

FIG. 6 is a flowchart illustrating in more detail the receiving and storing of the marketing interaction, and usage information in the database at the server.

FIG. 7 is a flowchart illustrating in more detail the receiving and processing of the information sent to the server from the wireless device and then returning to the wireless device application controls and marketing interactions.

FIG. 8 is a flowchart illustrating in more detail the server-side logic for managing access rights to the wireless device application.

FIG. 9 is a flowchart illustrating in more detail the possible user experience of the wireless device application upon application initiation.

FIG. 10 is a flowchart illustrating in more detail the possible user experience and marketing interactions within the wireless device application as controlled by information received from the server.

FIG. 11 is a flowchart illustrating in more detail the possible question and answer user experience interactions within the wireless device application.

FIG. 12 is a flowchart illustrating in more detail the possible user experience and marketing interactions within the wireless device application after the user has chosen to exit the application as controlled by information received from the server.

FIG. 13 is a flowchart illustrating in more detail the injection of the client software into existing Java applications.

FIG. 14 is a flowchart illustrating in more detail the processing of the variables and transmission headers.

### DETAILED DESCRIPTION OF THE INVENTION

The invention provides a method and system for delivering marketing interactions, restricting application access and tracking usage for wireless device applications directly from a wireless device. The following description is presented to enable one of ordinary skill in the art to make and use the invention and is provided in the context of a patent application and its requirements. Various modifications to the disclosed embodiments will be readily apparent to those skilled in the art and the generic principles herein may be applied to other embodiments. Thus, the invention is not intended to be limited to the embodiment shown but is to be accorded the widest scope consistent with the principles and features described herein.

The method and system of the invention deliver rich, user interactive, non-intrusive, relevant marketing to consumers on wireless devices. Rich user interaction includes, but is not limited to, use of full screen and banner static images, motion images, video, audio within and around applications as well as mobile web pages.

The invention provides the ability for users to interact with the advertisements, including but not limited to, being a part of market research, trivia or general user input that an advertiser or marketer is interested in receiving from the consumer. The ability for the user to watch a video, call the marketer, send a text message or email to the marketer, or to be directed to mobile web destinations from within the advertisement to explore and connect with more content and locations.

The non-intrusive nature of the invention provides low latency, i.e., no waiting for the ad to load. Advertisements are provided as part of the content experience. For interactive experiences, the invention takes a “holistic” and unique view of the user based on unique identifiers associated with the user's specific mobile device. As a result, marketing interactions, such as the user being asked a question (e.g. what year were you born?), will be asked only once across all applications.

Relevance is based on many individual elements including, but not limited to age, gender, demographic data and psychographic data about the individual as well as from usage patterns of the user within and around mobile content (such as, plays sports games on the phone and receives text alerts from sports teams).

The invention ensures the above characteristics for marketing across the mobile device by providing a simple solution for marketers which masks the many complexities of the wireless world. Complexities that include: different wireless technologies (such as CDMA, GSM, etc.); Operating Systems (such as Java, BREW, Symbian, Windows, Mobile, Linux, Android, OHA, Blackberry, etc.); Development (such as API versus BCI (Byte-Code Instrumentation)); Identity (such as MDN, ClientID, X-up-subno, etc.); Devices specific items (such as memory, heap, audio, video, screen size, network speed); and real-time monitoring and measurement of marketing campaigns.

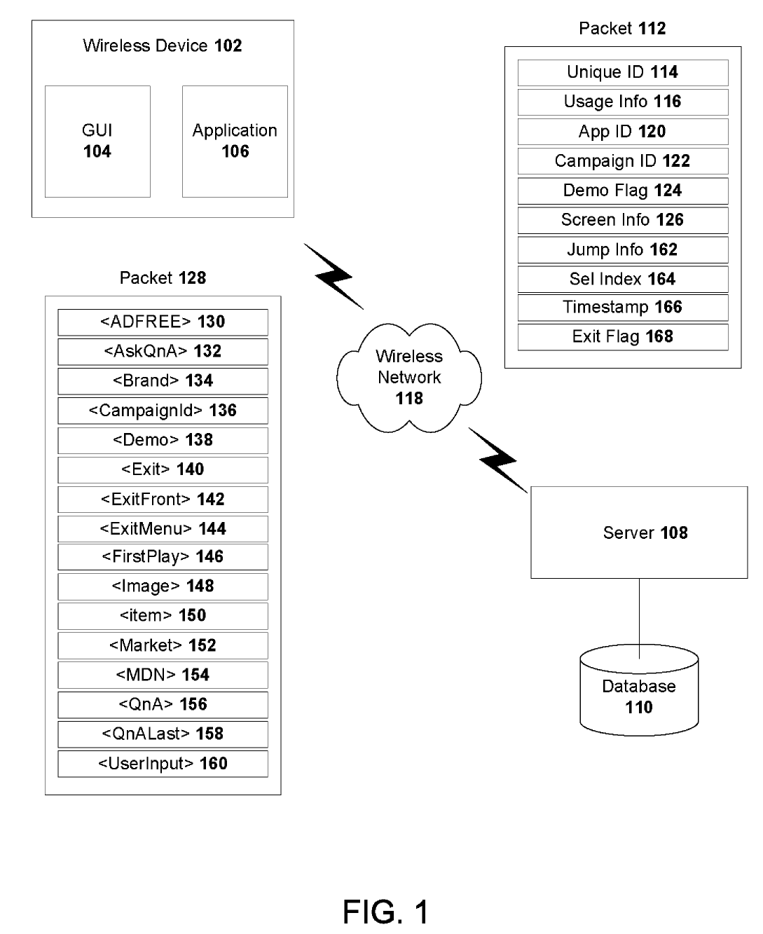

FIG. 1 illustrates an embodiment of a system for delivering marketing interactions, managing application access and usage tracking for wireless device applications directly from a wireless device. The system comprises a wireless device 102 and a server 108. The wireless device 102 communicates with the server 108 via a wireless network 118. The wireless device 102 includes an application 106 and a graphic user interface (GUI) 104. The server 108 has access to a database 110 for storing marketing components, campaign logic, business rules, access rights to content and usage tracking of wireless device applications. The wireless device 102 can be a mobile phone, a personal digital assistance, or some other apparatus with wireless communication capabilities. The application 106 can be any that executes on the wireless device 102, such as a game, video player, music player, browsers, etc. The application 106 uses the GUI 104 to communicate with the user of the wireless device 102.

To be granted access to the content, request and receive marketing interactions and take action upon individual marketing selections, the wireless device 102 sends a packet 112 to the server 108. The packet 112 contains the following:
unique identifier (Unique ID114) for the user of the wireless device 102;
current campaign information (Campaign ID122), including an identifier for the current marketing campaign;
cached marketing data (Usage Info 116) containing a time stamp information for current and previously seen marketing interactions that the server 108 has not yet been updated on; at a minimum, the cached marketing data is the timestamp of the current marketing interaction being displayed;
an application identifier (App ID 120) for the wireless device application 106;
content type information (Demo Flag 124) for providing information on the state of the content. If the demo flag 124 is zero “0”, then the application 106 is not limited in its usage. If the demo flag 124 is greater than zero, then the application 106 has limited usage. For example, if the demo flag=60, then the application 106 would exit after 60 seconds;
device display information (Screen Info 126) for providing information on the screen dimensions of the device 102. On most devices, the device information is added to the HTTP headers as it goes through the operator's WAP gateway. However, some devices do not use an operator's WAP gateway for network traffic. For this reason, the Screen Info flag 126 is used to designate the screen size of the device 102 in order to deliver appropriate images and font layout;
marketing interaction identifier (Jump Info 162), including a unique value associated with a menu item. This unique value represents a URL on the server 108 where the user should be taken to in the mobile browser;
menu selection identifier (Sel Index 164) for identifying the menu item selection by the user, e.g. 4^{th} menu item;
menu location identifier (Exit Flag 168) for identifying the location of the exit menu. An exit menu can occur before or after application use. The Exit Flag 168 identifies where the menu was displayed within the application 106; and
a timestamp identifier (Timestamp 166) including a timestamp for an activity on the device 102. All activities performed on the device 102 are time stamped. The timestamp represents the time the user performed the action.

The server 108 then processes the packet 112 and returns a packet 128 to the wireless device 102 containing a list of identifiers and data to be displayed for the wireless device application 106. The identifiers and data control the wireless device application 106 user experience. Potential identifiers that can be sent in packet 128 includes the following:
<ADFREE> 130, disables marketing interactions for the wireless device application 106;
<AskQnA> 132, prompts the user of the wireless device application 106 to be asked to input their age and birth year;
<QnA> 156, displays to the user the wireless device application 106 a question and a set of possible answers;
<Userlnput> 160, displays to the user of the wireless device application 106 a menu with one or more selections;
<Exit> 140, disables access to the wireless device application 106
<ExitFront> 142, a flag to control when the exit menu of the wireless device application 106 is displayed, such as at the beginning of the application launch;
<QnALast> 158, a flag to control when the question/answer interaction of the wireless device application 106 is displayed, such as at the end of the application launch;
<MDN> 154, updates the unique ID 114 information stored on the wireless device 102 to be sent in packet 112 of the wireless device application 106;
<CampaignlD> 136, updates the Campaign ID 122 stored on the wireless device 102 to be sent in packet 112 of the wireless device application 106;
<Image> 148, updates the forward cached next campaign image stored on the wireless device 102;
<Demo> 138, updates the current content access timer stored on the wireless device 102 of the wireless device application 106;
<Market> 152, updates the current message stored on the wireless device 102 of the wireless device application 106 to be displayed to the user during transmission of packet 112 to the server 108;
<FirstPlay> 146, controls the user experience on the wireless device 102 for the wireless device application 106 based on the current number of times the wireless device application 106 has been accessed;
<Brand> 134, controls the message on the wireless device 102 for the wireless device application 106 to be displayed to the user when the exit menu is displayed;
<ExitMenu> 144 controls the order and number of items to be displayed on the exit menu on the wireless device 102 for the wireless device application 106; and
<item> 150, defines the menu label and menu key for each exit menu item on the wireless device 102 for the wireless device application 106.

The inventive method and system provides several features, as described below.

Client Software. The client 102 has software that connects to the server 108 over the wireless networks 118, passing information to the server 108 about the user identity (Unique ID 114), the content identity (App ID 120), campaign identity (Campaign ID 122) and the wireless carrier identity. The server 108 returns a payload of information back to the client 102, and the client 102 renders the marketing interactions that can include marketing messages and images, calls to action (such as click to call, click to coupon), question/answers, and exit menus to the end user.

Injection Technology. The invention includes a process which leverages third party software to inject the inventive client-side code into completed applications for J2ME. Java byte-code (compiled code) is inserted into the compiled code of the application 106. This eliminates the need for developers to embed an API during development.

PolicyManagement. The server 108 provides for expiration of content for users and for individual licensing and access control. For the expiration of content, the flow is as follows:
Application 106 starts→Application 106 initiates network session to server 108→Server 108 queries database 110 by App ID 120 to see if application 106 is expired, returns expired to Application 106. Application 106 displays “Content Expired” and exits.

Individual licensing and access control can be based on any number or combination of factors, such as: Time based play (e.g, 30 seconds, 1 day, 1 week, 1 month); Max # plays (e.g., 5 plays); Min # plays (must play X times to generate X impressions within a specific time period); Arcade models Access to X application over Y period of time regardless of application; Time of day, location, or age verification access to content; Try-before-buy; and Unlimited access. The above “rights” to content can be combined (i.e 5 plays max with each play 30 seconds in length) as well as depend on where the content was downloaded. For individual licensing and access control, the flow is as follows:
Application 106 starts→Application 106 initiates network session to server 108→Server 108 queries database 110 byApp ID 120, Unique ID 114, download_Server_id (identifier for server 108) to see if application 106 is accessible by the user, returns expired or unauthorized to Application 106. Application 106 displays a message such as “Content Expired” or “Access Denied” and either exits or provides additional options to the user.

All content access can be universally revoked as well as individually revoked. This can be done based on carrier/portal and or publisher requirements in order to control access to content. This allows for application 106 to be turned off in the event of possible virus or threats from the application executing.

Real time consumer interaction and usage tracking. When the application 106 is launched, the first thing that occurs is the application 106 initiates a network request to the server 108. This is contrary to approaches currently in the industry. In some current approaches, a series of advertisements that the user will view over many starts are cached on the device. However, there is a possibility that the user stops using the application 106 before the stored information is sent to the server 108 for logging. The inventive approach for connecting to the server 108 every time allows for real-time reporting of the marketing interactions as well as for all license details.

There is logic that is added to the client 102 that allows for access to content without network coverage. If a user is in a location with no network coverage, access to the content can be granted during this period. All access is logged and transmitted to the server 108 the next time the user is in network coverage and launches the application 106.

In-game messaging to user. Messages (e.g. check exit links for coupon, 5 more plays to keep game next month) can be provided to the user within the game. The flow is as follows:
Application 106 starts→Application 106 initiates network session to server 108→Server 108 queries database 110 by App ID 120 and Unique ID 114 to see if there is a message that is pending to be sent to the user.

Many types of messages can be communicated to the user prior to application usage, such as “You have 5 more game plays to be entered into the sweepstakes”, “You have 4 more game starts to keep this game next month”, or “At the end of the application, choose Exit and sign up for more free stuff”.

Brand/Content conflict There are business rules and logic built into the server 108 to have control over the partnering of a branded message within an application. These controls are exposed to users of the inventive solution via an extranet. Users of the inventive solution can be Content Creators, Content Publishers, Brands and Agencies, Distributors such as wireless operators or off-portal solution providers as well as individual consumers. For instance, a brand can deselect certain content they want their message in (i.e. a sports drink distributor is only interested in being in content that reflects their product's lifestyle). As well, the content can deselect brands that are inappropriate for their application (i.e. No Cialis advertisement in the SpongeBob game). The flow is as follows:
Application 106 starts→Application 106 initiates network session to server 108→Server 108 queries database 110 by App ID 120 to render the appropriate marketing interactions.

User/Brand selection. The user is able to explicitly select brands that she is interested in and those she is not interested in. Brands that the user is not interested in are not shown to the user. The user will go to a web page with a list of brand marketers listed (fast food, restaurants, apparel, sports, energy drinks, etc.) The user can deselect categories that she is not interested in or select brands that she is interested in.

User targeted advertising. Advertising can be based upon an explicit request for user information, demographic profiling, geo-targeting, content profiling, and/or user behavior (past and present). Along with the explicit de-selections available to users of the invention, a targeting engine (not shown) of the server 108 will determine the appropriate marketing interactions a user will have. Assuming access to the content is granted and marketing interactions are set to occur in the content, the targeting starts by determining if the user is currently in an active campaign. Active campaigns take precedence over new campaigns. The flow is as follows: the application 106 starts and initiates a network session to server 108; server 108 queries the database 110 by App ID 120 and Unique ID 114; if the user is currently in an active campaign, then the user will continue that branded experience; if the user is not currently in an active campaign, the user is placed into a new campaign based on certain factors. These factors may include one or more of the following: No brand conflict; User has not previously completed this defined campaign; User meets the criteria for the marketing engagement based on user, user demographic, explicit user request, location of user, type of content, demographic profiling, past behavior, etc.; Highest bidder by the brands for this user.

Asking questions. Within the content, the invention provides the ability to participate with the user in a question and answer session. This could be trivia to entertain the user or product research for the brand to gain insight into a user's thoughts. The flow is as follows: the application 106 starts and initiates a network session to the server 108; the server 108 queries a database 110 by App ID 120 and Unique ID 114; the server 108 returns to the client 102 the next question to the user, which can be based on the result of a previous answer by the user to a previous question; the application 106 displays the question and answer to the user after viewing the branded full screen splash, banner or other form of marketing interaction; the user selects an answer and then the results are posted to the server 108.

Demographic questioning within application. Within the content, demographic information can be gathered from the user. This allows, over time, the ability to collect information about the user to provide further targeting. The flow is as follows: the application 106 starts and initiates network session to server 108; the server 108 queries a database 110 by App ID 120 and Unique ID 114; the server 108 returns to the client 102 the next demographic question for the user, which can be based on the result of a previous answer by the user to a previous question; the application 106 displays the question and answer to the user; the user selects an answer and then the results are posted to the server 108. Upon start of the first piece of content, the user can be asked Gender and Birth Year from within the application 106, thus starting the profiling possibilities.

Advertiser bidding. The invention provides automated placement of interactive advertising in mobile applications, where targeting is based on user, content, phone type, carrier, time of day, and/or location. From an extranet site, the advertiser will be able to upload media assets (full screen images, question answers, audio, video), and other provisioning information. They will be able to select what type of user they want to engage in a marketing session based on user (age, gender, habits), content, phone type, carrier, location, time of day. Once the user starts a campaign, the campaign can be time dependent (30 days), number of impression/question dependent, across content or specific to a piece of content.

Common identity across applications. With the invention, the same demographic or brand questions need not be asked more than once. The invention tracks each user uniquely regardless of application being used. This provides accurate information about a user's usage pattern regardless of what application they use as well as from where they downloaded the application. It does this by capturing unique information about the user during the network transmission or by asking the user to provide the unique information such as the phone number. The flow is as follows: the application 106 starts and initiates network session to server 108; during each transmission to the server 108, the client 102 passes the phone number or other unique user information, App ID 120, Campaign ID 122, and additional information including usage data to the server 108. The platform does not require the phone number to be passed from the client 102 as it can capture unique identity information passed in the WAP headers during download of the content. With each client to server session, the same unique information regarding the user is passed to the server 108. For this reason, regardless of content initiated, there is a 1-to-1 mapping of a user to a phone, allowing the invention to manage branding campaigns across content. Thus a user may start a campaign, and get question #1 of the campaign in a game. When the user starts his or her weather application, the user is asked the second question in the branded campaign, based on their answer to question #1 in the game. By having this capability, demographic questions to the same user need only be asked once.

Upsell/Cross sell merchandising “shelves ”. For each piece of content, the following parties are involved: Content publisher; Marketer; the content itself; the mobile carrier for the user; the location where they downloaded the content, off-deck or on-deck. Each component in this experience has up-sell/cross-sell shelf space in the exit menu. The content publisher can link to visit the publisher mobile web destination. The marketer can link to visit the marketer. The content itself can link to other content. The mobile carrier for the user can link to mobile carrier deck. The location where they downloaded the content—off-deck or on-deck—can link to off-deck location. Along with this up-sell/cross sell shelf-space, there is the ability to rate the content or recommend the content to peers via SMS or email.

Exit menu selections including Recommendations. At the end of the application 106 or before entering the application 106, the user can be presented with exit menu options. If the user chooses any menu option (including the rate content or recommend menu option) in the application 106, the following occurs:

If the user chooses to exit the application 106 from an exit menu that is displayed prior to using the application 106, the user will be asked to confirm that they wish to exit the application 106. If the user chooses to exit, or has already exited the application 106 prior to seeing the exit menu, the application 106 launches the mobile web browser and “jumps” to the URL hosted by the platform. The “jump” URL logs the App ID 120, Campaign ID 122, Unique ID 114, time of request, and where the user wants to go. The “Jump” process then redirects the user to the appropriate mobile web destination. If the mobile web destination is one that the server 108 powers (i.e., rate or recommend content) then the mobile web page can be branded at the top with the same brand/advertiser as was in the content prior to launching the mobile web. This branding stays with the mobile web session as long as the user remains on a mobile web page powered by the server 108. If the user chooses to recommend the content to a peer, the user is asked if they would like the recommendation to be sent via email or SMS.

If the recommendation is sent via SMS, then a link to download the recommended content is sent to the recipient. The message is branded by the brand/advertiser as was in the content and the mobile web pages. If the recommendation is sent via email, then an email message is sent to the recipient. This message is branded by the brand/advertiser as was in the content and the mobile web pages. The link to download the content points to the location / storefront that the sender originally downloaded the content from.

Acquisition links—Click to recommend, Click to call, click to video, click to SA4S, click to WAP. From within the content there are ways to “jump” out of the content to browse mobile web destination, send an SMS, make a voice call or watch a video. The system leverages the capabilities of the browser to perform all of these functions.

Synchronization of ad campaigns across content. Since campaigns are centered on the user and not the content, it is inevitable that within a particular content, the branded marketing interactions will get out of sync. For example, a user starts a campaign with a brand in a game and answers question #1 of a 3 question campaign. Next, the user launches the weather application and answers questions 2 and 3 of the campaign and then start a second campaign. When the user starts the game again, the campaign is out of sync for this user within the game. On the platform, when this occurs, the server 108 synchronizes the content with the current campaign, sending back to the client 102 content information regarding the current campaign.

Forward caching logic upload the next campaign before the current campaign ends. To address the possibility of latency in wireless networks, as well as to minimize “dead time” for the user, an embodiment of the invention uses a forward caching scheme. Upon the last instance of a campaign, the client 102 will receive from the server 108 the information required for the next campaign which the user will not see until the application 106 is started the next time.

Remove the ads/up-sell. Typical up-sell solutions (a demo version up-sell to the full version) require the user to download the new version of the application. With the invention, advertisements can be removed from the content, not requiring the user to download a new version of the content. This is done by notifying the client 102 to not go to the network any longer or at the server 108 to no longer supply advertising to that specific user within that specific content.

User acquisition or other action up front. There are times where it may be important to provide the user with the ability to “jump” to sites before engaging with the application 106. (i.e., sign up for a coupon, enter a sweepstakes, limited time offer, etc) The invention allows for this capability as well as for the exit menu to be displayed before the application play. The same configurability can be performed on the question answer capabilities of the invention. For example, the survey question can be asked at the end of application usage, as opposed to the beginning.

Tracking key strokes for answers to questions. It is important to understand what the end user is doing/thinking while engaged in a branded marketing experience. For marketing interactions involving questions and answers, the invention can track if a user is always choosing the first/default option which may be a sign the user is not engaged with the brand, but just pressing a button to move on.

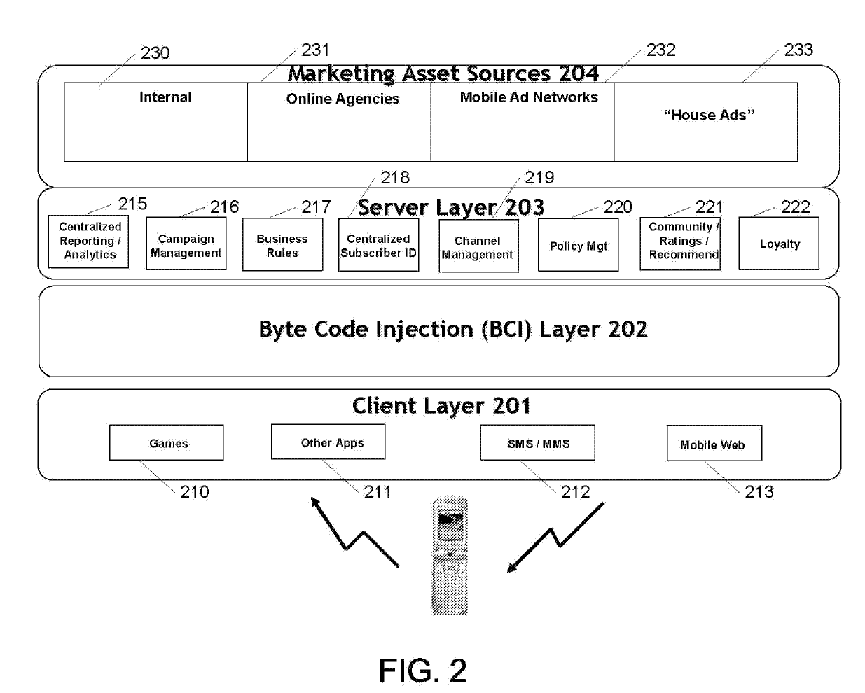

FIG. 2 illustrates an embodiment of a platform for the delivering of marketing interactions. The client layer 201 represents the User Interface or GUI 104 of the device 102. This interface 104 can be within an application (games 210 or any other application 211 on the device 102), Mobile Web 213, SMS or MMS 212. The Byte Code Injection (BCI) layer 202 is a technology that inserts client code into Java applications. The server layer 203 includes the server side interfaces that perform the logic for the system features, including:
centralized reporting analytics 215: Consumer interaction information is sent to and stored at the server 108. This information is sent to the server 108 in real time and can be acted upon in real time. This data can also be analyzed and reported upon at other time frames such as end-of-month reporting;
campaign management 216: Campaign management controls the types and lengths of marketing campaigns within an application for a given user on a given device;
business rules 217: Business rules are rules to control which marketing assets are available to be displayed within a particular application on a given device for a given user. Rules can be set by the distributor of the application, by the publisher of the application, by the advertiser or marketer as well as by the content itself For example, the advertiser of a drink wants to have their advertisements shown only in genx and genY sports games;
centralized subscriber ID: the centralized subscriber ID is a unique identity representing a single subscriber. All interactions are keyed to a unique identity;
channel management: Channel management are business rules to ensure the management of the user experience and to ensure that the user is directed to and interacts with the correct provider of the marketing and merchandising interactions For example, when a user who downloaded an application to a carrier device from an off-deck content provider launches the application, channel management modules can ensure that any up-sell or cross-sell of new digital content can be directed to the off-deck provider instead of to the carrier storefront;
policy management: As defined earlier in this Specification, policy management manages the content access controls of the system. When a user launches an application 106, the application 106 checks the serve to see if the content can be accessed and if so for how long;
community/ratings/recommendations: Applications can be rated as well as recommended to others. This information is tracked by the user performing the interactions. Profile information on the user can also be captured; and
loyalty: Loyalty is a points based activity solution. Since all activity is keyed to a unique user within the system, points or other awards can be set for activities completed.

The system features are described further below. The marketing asset sources 204 are those entities that manage and control the physical assets of the marketing interaction. The assets can include full screen or partial screen images, banner images, animation or videos, survey questions and answers and merchandising elements. The marketing asset sources can include: sources internal 230 to the system, online agencies 231, mobile ad networks 232, and “house ads” 233. House ads are assets that are from the distributor. For example, if this service is being provided for a particular carrier and the advertisements that are going to be displayed are ads from the carrier, then these are “house ads”.

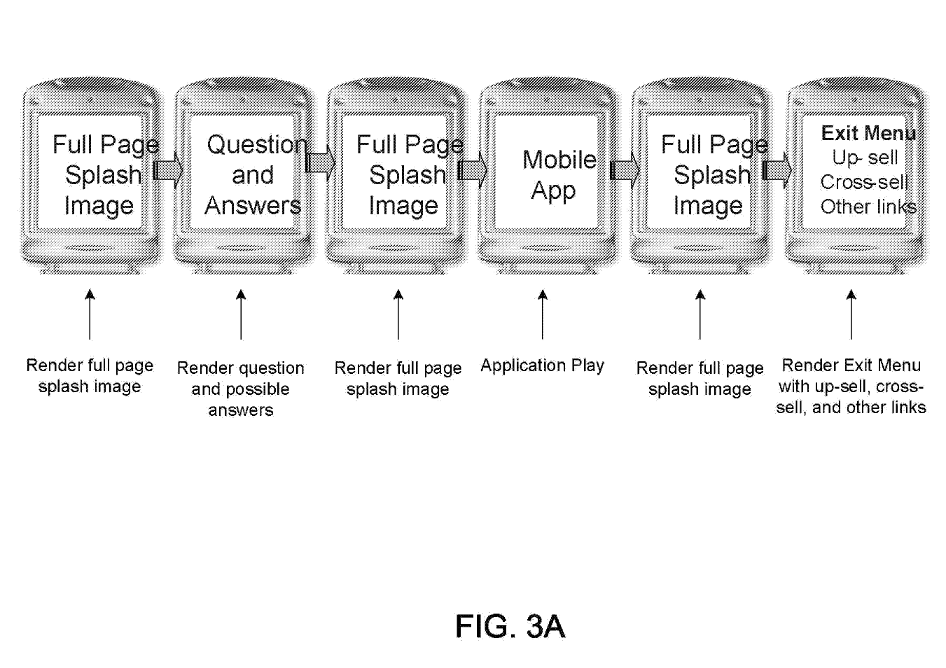

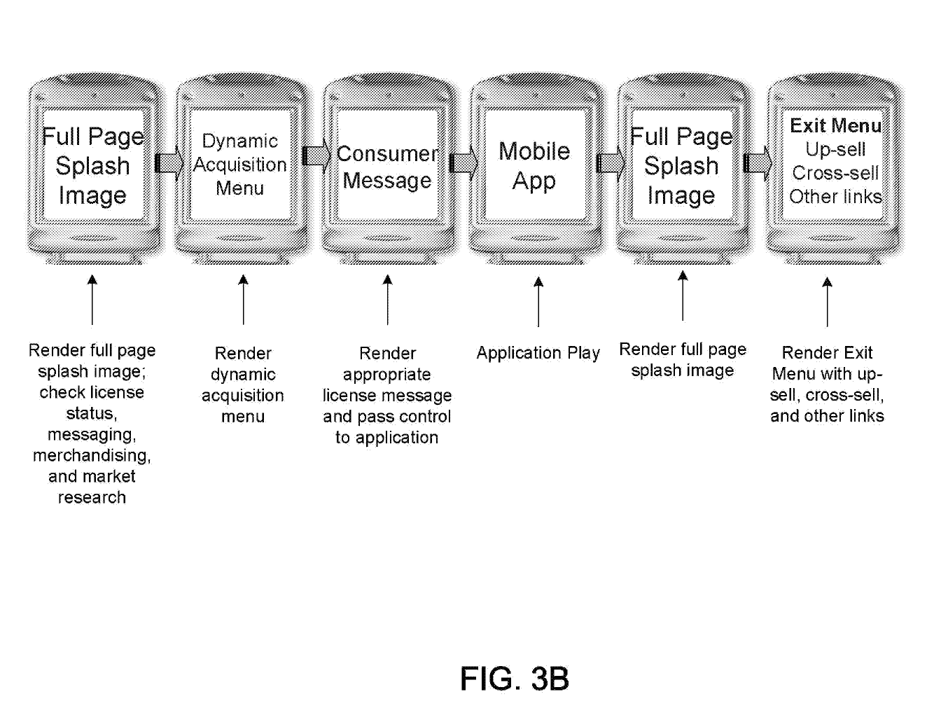

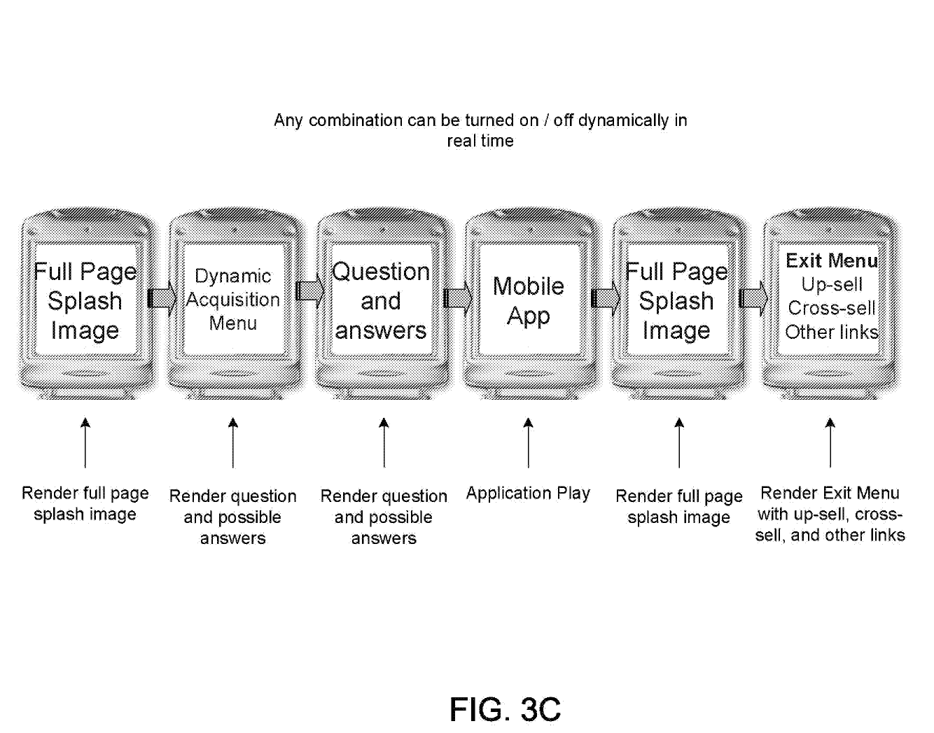

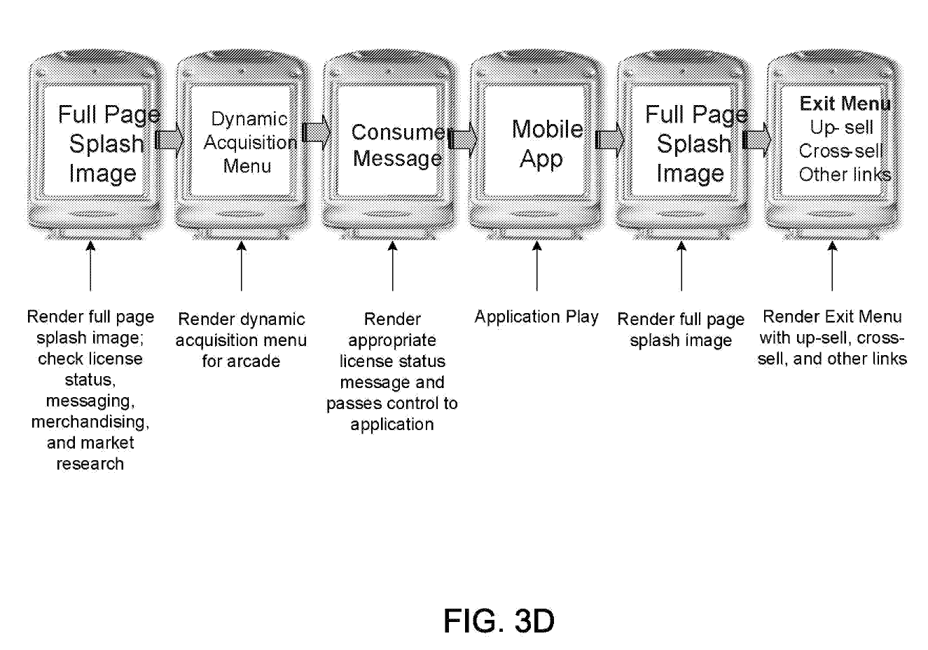

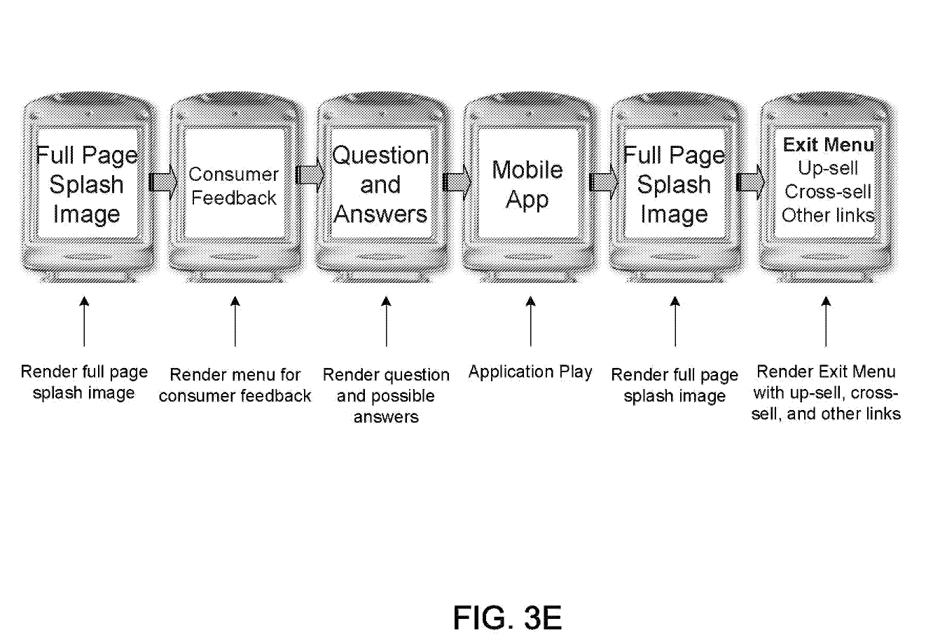

FIGS. 3A-3E illustrate example consumer experiences of the inventive deliverance of marking interactions. The user experience can be determined by the content, the user engaged in the content and the location where the content was downloaded. There are several user experiences that can be configured with the invention. FIG. 3A illustrates a pure advertising supported model. Here, advertisements are displayed in the content and the content can be subsized by the advertisements. FIG. 3B illustrates a try-before-you-buy model where content can be access and used for a limited amount of time. FIG. 3C illustrates the ability to perform merchandising within the content with the ability to up-sell and cross-sell other digital goods. FIG. 3D illustrates an arcade model for access to content where subscribers can have access to use all applications within the arcade, however access can be granted on a limited number of applications in a given time frame. For example, if the arcade had 50 games that could be purchased, the arcade model could be that for $9.99 per month, the user can play up to 5 of the 50 games during a given month. FIG. 3E illustrates the community elements that are available to the content such as the ability to tell a friend about the application, rate the application, update a community profile or offer community programs. All of these examples can occur together or separately within the content.

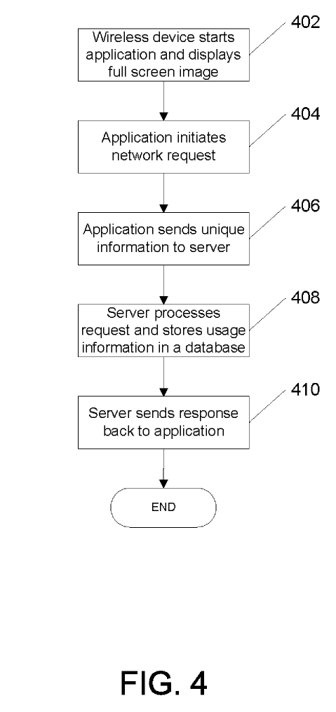

FIG. 4 is a flowchart illustrating an embodiment of a method for requesting marketing interactions, application access and usage tracking for wireless device applications directly from a wireless device. The device 102 starts the application 106 and displays a full screen image using the GUI 104 (step 402). During the display of the full screen image, the wireless device application 106 initiates a network request (step 404). The application 106 sends unique information in the form of packet 112 to the server 108 (step 406). The server 108 processes the request and stores (step 408) usage information (e.g. application start time, current campaign impression being shown, time of impression, as well as possibly age, gender information if this was asked of the user) in database 110. The processing of the request is described in more detail later in this specification. Based upon the unique information transmitted to the server 108, the server 108 sends a response (step 410) back to the wireless device application 106. The response is provided as packet 128, described above. The processing of the response by the wireless device application 106 is described later in this specification.

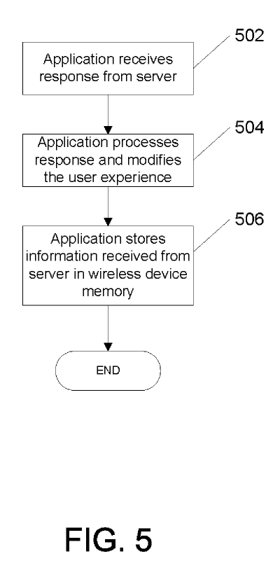

FIG. 5 is a flowchart illustrating an embodiment of a method for receiving marketing interactions, application access by wireless device applications directly from a server. A wireless device application 106 receives a response (step 502) from the server 108. The wireless device application 106 processes the response and modifies the user experience according to the response (step 504), as seen in the wireless device application 106 displayed using the GUI 104. The wireless device application 106 stores the information received from the server 108 (step 506), using the device memory. In one embodiment, the client 102 is developed to use a minimal amount of memory. After the initial marketing interaction (prior to the application 106 starting) the client 102 removes itself from the application memory footprint. Storage of the information sent to the client 102 is necessary in order to present the user with marketing interaction after the user decides to exit the application 106. The client 102 will re-appear when the user chooses to exit the application 106 and the client 102 will read the information stored to present the correct user experience. Also, in order to improve the user experience and eliminate the need for the user to wait for marketing images to return from the server 108, the client 102 is built with a forward campaign caching model. When the user starts the application 106, the user sees the splash screen that was stored onto the device 102 and represents the current campaign. During the network request, the server 108 will return the splash image for the next campaign to be seen upon the next application start (assuming the current campaign has concluded).

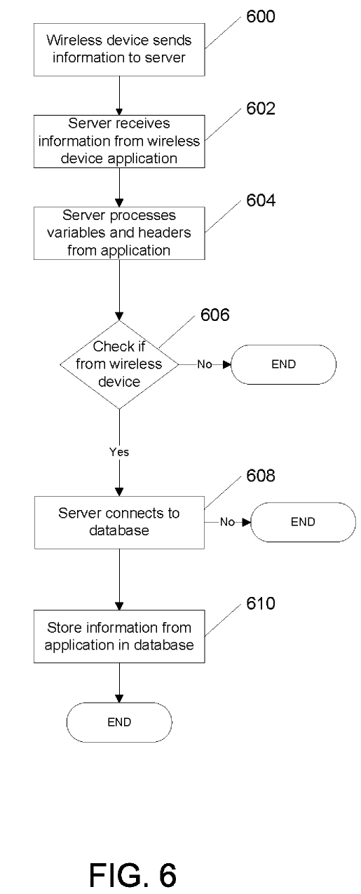

FIG. 6 is a flowchart illustrating in more detail the receiving and storing of the marketing interaction and usage information in the database at the server. A wireless device application 106 sends unique information provided by packet 112 to the server 108 (step 600). The server 108 receives the information from the wireless device application 106 (step 602) and processes the variables and transmission headers sent from the wireless device application 106 (step 604). The variables are those described in packet 112. In this embodiment, client-to-server communication is done via HTTP (Hypertext Transfer Protocol), although other protocols may be used. The HTTP protocol is set up to pass HTTP headers. During the mobile communication to the server 108, several of these “transmission headers” are captured at the server 108. Some headers define the type of device. In some cases, special headers are received that are the unique identifier of the user. The server 108 checks (step 606) to see if the information was sent to it from a wireless device 102 by evaluating several HTTP transmission headers, including User-Agent, ClientID, XNUP_SUBNO, and WAP_PROFILE. If the checks shows that the information was from a wireless device, then the server 108 connects to the database 110 (step 608), and the information sent from a wireless device application 106 is stored (step 610) in the database 110.

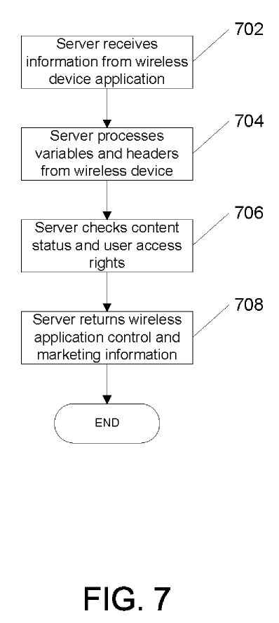

FIG. 7 is a flowchart illustrating in more detail the receiving and processing of the information sent to the server from the wireless device and then returning to the wireless device application controls and marketing interactions. The server 108 receives unique information provided by packet 112 from a wireless device application 106 (step 702). The server 108 processes the variables and transmission headers (step 704) sent from the wireless device application 106. The server 108 checks content status and user access rights (step 706). Content can have a status of active or not-active. If the content has a status of not-active, then the user will get a message stating the content is not usable. Content status is returned via the <Exit> tag 140 returned in packet 128. The server 108 returns application control and marketing information as defined by packet 128 (step 708) to the wireless device application 106.

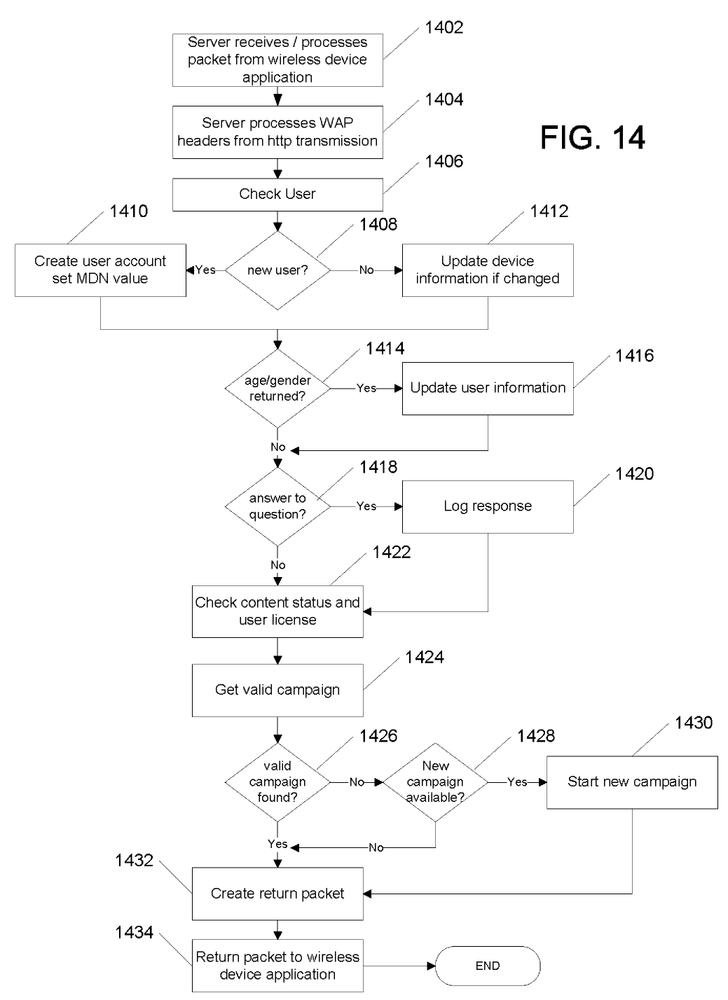

FIG. 14 is a flowchart illustrating in more detail the processing of the variables and transmission headers. First, the server receives and processes the packet 112 from the wireless device application (step 1402). The server 108 processes the WAP headers from the HTTP transmission (step 1404). The server 108 then checks the database 110 for a record for the user (step 1406). If the user is a new user (step 1408), i.e., the database 110 contains no record for the user, then the server 108 creates a user account by assigning a unique ID to the user, storing the user account in the database 110, and setting the MDN value in packet 128 to the unique ID (step 1410). If the user is not a new user (step 1408), i.e., the database 110 already contains a record for the user, then the server 108 updates (step 1412) the device information stored in the database 110 if changed, with the device information from the HTTP headers.

Next, the server 108 determines if the user's age and/or gender were returned with packet 112 (step 1414). If so, then the user record in the database 110 is updated with this information (step 1416). The server 108 also determines if packet 112 returned an answer to a question that was posted on the device 102 to the user (step 1418). If so, then the response is logged in the database 110.

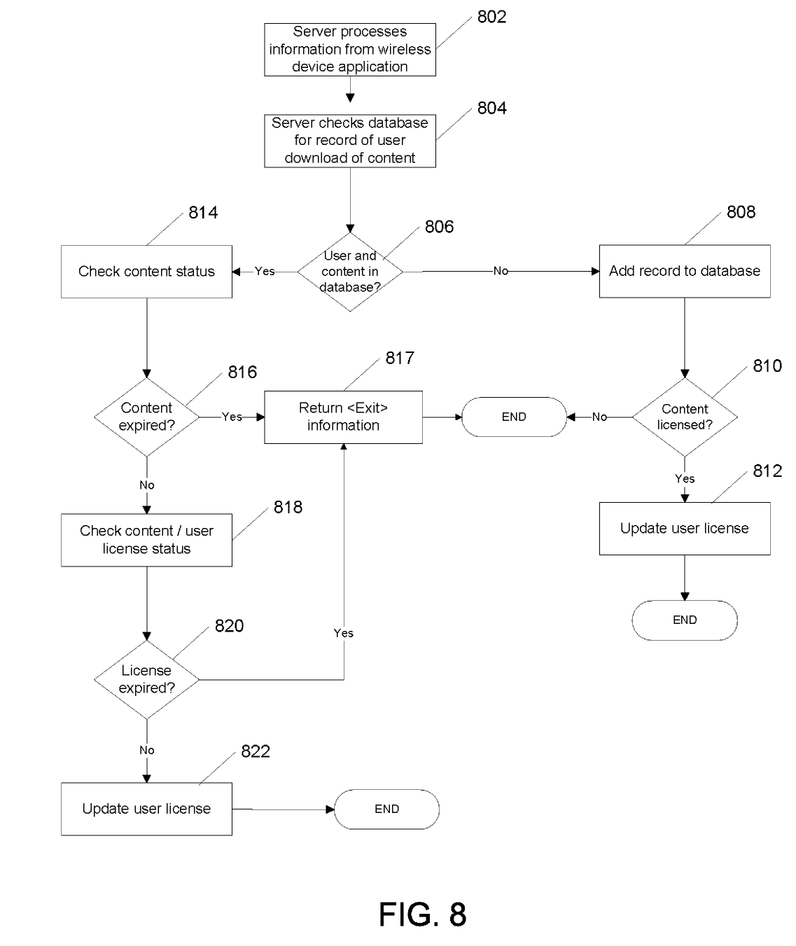

Next, the server 108 checks the content status and the user license stored in the database 110 (step 1422), and attempts to get a valid campaign corresponding to the Unique ID 114 in the packet 112 from the database 110 (step 1424). The checking of the content status and the user license is further described below with referenced to FIG. 8. If no valid campaign is found (step 1426, then the server determines if a new campaign is available (step 1428). Determination of the availability of a new campaign is based on the business rules applicable to the user, the application 106, and/or the distributor and/or the device 102, including but not limited to brand/content conflict, user/brand selection, user targeted advertising, etc. (see description above). If a new campaign is available, then the server 108 starts the user on the new campaign (step 1430) by setting the Campaign ID 136 in packet 128 to the identifier for the new campaign and setting the Image tag 148 in the packet 128 to the new campaign full screen asset. The other data in packet 128 is set as well based upon the campaign information. Once the creation of packet 128 is complete (step 1432), the packet 128 is returned to the wireless device application 106 (step 1434).

FIG. 8 is a flowchart illustrating in more detail the server-side logic for managing access rights to the wireless device application. After receiving unique information provided by packet 112 from a wireless device application 106, the server 108 receives and processes the information (step 802). (See FIG. 14.) The server 108 checks (step 804) if the database 110 already has a record for a he user download of the wireless device application 106. If the database 110 has no record of the user download (step 806), a record is added (step 808) to the database 110 for the user download. Then, the server 108 checks the database 110 (step 810) for a record of the wireless device application 106 license. If the content has a license, a re-existing user license record in the database 110 is updated (step 812) to reflect the new user license for the wireless device application 106. If the database 110 has a record of the user download (step 806), the content status of the wireless device application 106 is checked (step 814) in the database 110. If the wireless device application 106 is in the expired state (step 816), the server 108 returns (step 817) <Exit> information 140 back to the wireless device application 106 in the packet 128. If the wireless device application 106 is not in the expired state (step 816), the status of the user license for the wireless device application 106 is checked (step 818) in the database 110. If the database 110 record shows the user license has expired (step 820), the server 108 returns (step 817) <Exit> information 140 back to the wireless device application 106 in packet 128. If the database 110 record shows the user license has not expired, the user license record for the wireless device application 106 is updated (step 822) to reflect the user's usage of the application 106.

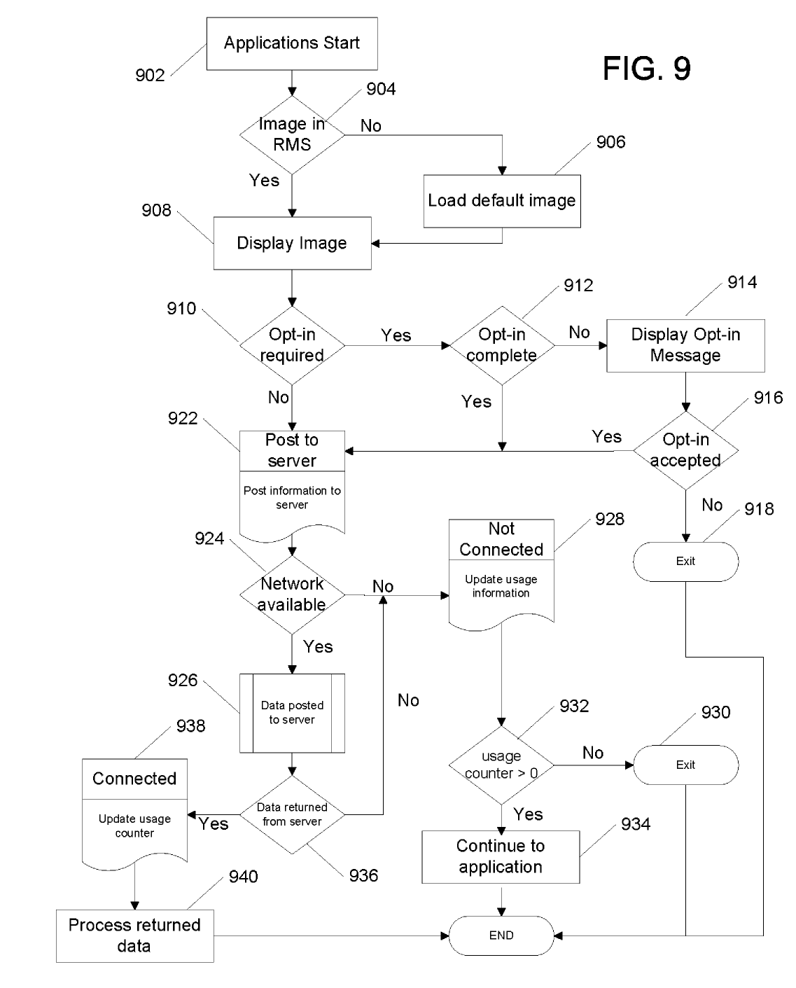

FIG. 9 is a flowchart illustrating in more detail the possible user experience of the wireless device application upon application initiation. When the wireless device application 106 is started (step 902), it checks its local storage (RMS) (step 904) for a pre-cached image. The pre-cached image is the forward cached splash, as defined above. While the client 102 connects to the server 108, the user is viewing the splash of the current campaign. Assuming the user is transitioning from one campaign to another, the device 102 will receive and store the splash for the next campaign that will be seen upon the next application start. If no image is found (step 904), the wireless device application 106 loads a stored default splash image (step 906). This default splash image is used on the first application start during the network request from the client 102 to the server 108. This image is displayed so as to not have “dead-time” during the network request. The image is displayed (step 908) on the wireless device application 106 in the GUI 104.

The wireless device application 106 then checks if an “opt-in” in required (step 910) for access to the wireless device application 106. In the case of advertising a sponsored application, there is a guideline in the industry that the user must opt-in for marketing interactions. In some cases, a double opt-in is required, which applies mostly to off-deck sales of content. There's an assumption that the user has been made aware that there will be advertisements or marketing interactions in the content prior to download. The first opt-in occurs when the user chooses to download the application 106. A flag stored on the device 106 is then set, so that when the user launches the application 106 for the first time, the user is asked to opt-in a second time by agreeing to advertisements or marketing interactions being displayed in the content. If the user chooses not to opt-in, the user can not use the content.

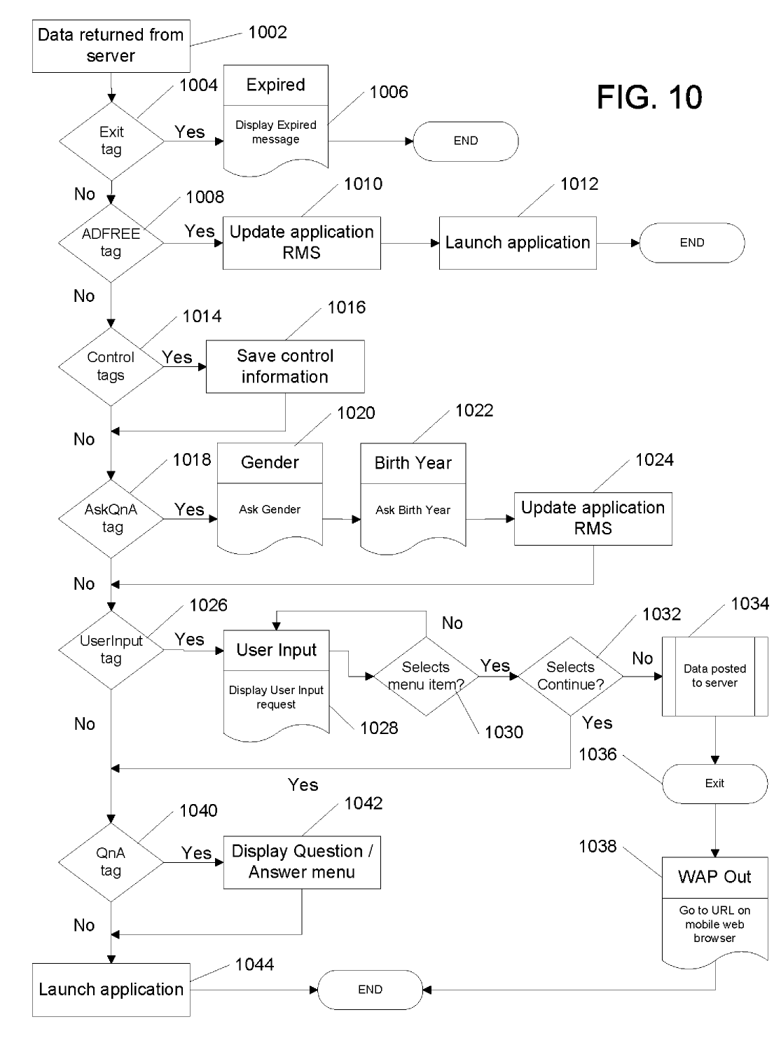

If an “opt-in” is required (step 900), the wireless device application 106 checks to see if the “opt-in” has been completed (step 912), i.e., the user chose to opt-in. If the “opt-in” has not been completed, i.e, the user has not chosen to opt-in, the wireless device application 106 displays an “opt-in” message (step 914) to the user via the GUI 104. The user can either accept or reject the opt-in. The wireless device application 106 checks if the “opt-in” is accepted (step 916). If the “opt-in” is not accepted, the application 106 exits (step 918). If the “opt-in” is accepted (step 916) or if the “opt-in” had been completed previously (step 912), or if no opt-in is required (step 910), the wireless device application 106 initiates a network request (step 922) to the server 108 in order to post information to the server 108. Such information includes the variables and transmission headers from packet 112, as described above. If the network 118 is available to receive a request (step 924), the device 102 tries to create a network connection for the request to use. The wireless device application 106 then posts the information (step 926) to the server 108. The wireless device application 106 checks for data to be returned (step 936) from the server 108. If data has been returned (step 936) from the server 108, the wireless device application 106 updates usage counters (step 938) for the application 106 and processes the data (step 940) returned from the server 108. The processing of the data returned from the server 108 is described further below with reference to FIGS. 10 through 12. If the network 118 is not available to receive requests (step 924) or if data is not returned from the server (step 936), the wireless device application 106 updates usage information (step 928) stored on the device 102. One such usage information can be a free play counter in the RMS for the application 106. The free play counter, defined by the client 102, reflects the number of times an application can be used without a connection to the network and communication with the server. The counter starts at a number and decrements for each consecutive start. For example, if the application 106 defines the free play counter to be a maximum of three, then the user can start the application 106 and play for three times before the application 106 becomes unusable or until a network request completes successfully. A free play text is also displayed, which can take many forms, such as “Network request failed. You have 2 free plays remaining.” And “Network request failed. This application requires network access to continue.” The wireless device application 106 checks the usage counter to see if the user is allowed to continue (step 932) with the wireless device application 106. If the usage counter equals zero (step 932), i.e., the number of uses has expired, the wireless device application 106 exits (step 930). If the usage counter is greater than zero (step 932), i.e., the number of uses has not expired, the user is allowed to continue with the application 106 (step 934).

FIG. 10 is a flowchart illustrating in more detail the possible user experience and marketing interactions within the wireless device application as controlled by information received from the server. The wireless device application 106 receives data (step 1002) returned from the server 108 in the form of packet 128. The wireless device application 106 checks for an <Exit> tag 140 in packet 128 (step 1004). If an <Exit> tag 140 is returned to the wireless device application 106, an expired message (step 1006) is displayed to the user of the wireless device application via the GUI 104 to inform the user that his or her right to use the application 106 has expired. If no <Exit> tag 140 is returned to the wireless device application 106, the wireless device application 106 checks for an <ADFREE> tag 130 (step 1008) in packet 128. If an <ADFREE> tag 130 is returned to the wireless device application 106, the wireless device application RMS is updated accordingly (step 1010) and the wireless device application 106 continues to launch (step 1012) without displaying any marketing interactions. If no <ADFREE> tag 130 is returned, the wireless device application 106 checks for additional control tags (step 1014). For each control tag returned to the wireless device application 106, the wireless device application 106 saves the control information (step 1016). The wireless device application 106 next checks for an <AskQnA> tag 132 in packet 128 (step 1018). If an <AskQnA> tag 132 is returned to the wireless device application 106, a request to the user to input their gender (step 1020) is displayed to the user of the wireless device application 106 via the GUI 104. A request to the user to input their birth year (step 1022) is also displayed to the user. Both the gender and birth year information inputted by the user are stored (step 1024) by the wireless device application 106 by updating the application RMS. The wireless device application 106 proceeds to check for an <Userlnput> tag 160 in the packet 128 (step 1026). If a <Userlnput> tag 160 is returned to the wireless device application 106, a menu requesting user input (step 1028) is displayed to the user of the wireless device application 106 via the GUI 104. The wireless device application 106 checks if the user has selected a menu item (step 1030). If so, then the application 106 checks if the Continue menu item was selected (step 1032). If not, then the wireless device application prompts the user to confirm they are interested in leaving the wireless device application. A network request is then initiated and data is posted (step 1034) to the server 108. The wireless devices application 106 exits (step 1036), and the user is taken to a URL on a mobile web browser (step 1038). If the user selected the menu item to continue (step 1032), the wireless device application 106 checks for a <QnA> tag 156 in packet 128 (step 1040). If a <QnA> tag 156 is returned to the wireless device application 106, a question and answer menu (step 1042) is displayed to the user of the wireless device application 106 via the GUI 104. If no <QnA> tag 156 is returned to the wireless device application, the launch of the wireless device application (step 1044) continues.

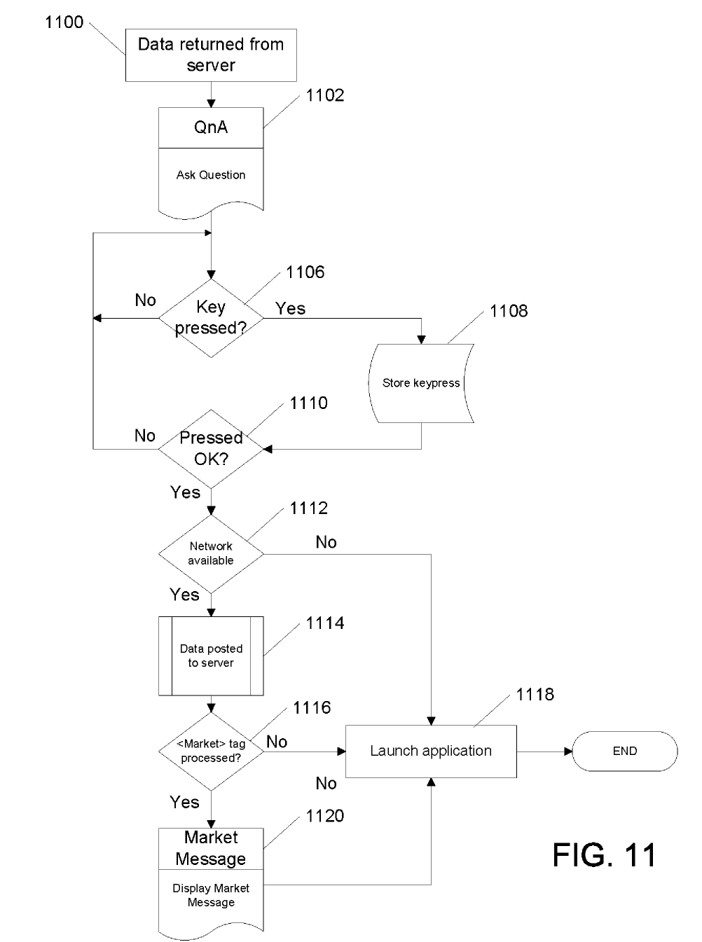

FIG. 11 is a flowchart illustrating in more detail the possible question and answer user experience interactions within the wireless device application. The wireless device application 106 receives data 1100 from the server 108. A check for the <QnA> tag 156 returns ‘success’ and the user is presented with an interface that has a question and possible answers to the question (step 1102). The wireless device application 106 checks for any key presses (step 1106) until the user presses a key. All key presses are stored (step 1108) by the wireless device application 106. If the user presses the “OK” key (step 1110), the wireless device application 106 initiates a network request. The wireless device application 106 checks for availability of network access (step 1112). If network access fails, the launch of the wireless device application 106 proceeds (step 1118). If network access is successful, data is posted to the server (step 1114). During the network request, the wireless device application 106 checks (step 1116) to see if it processed the <Market> tag 152 in packet 128. If a <Market> tag 152 was processed, then during the network request to post data to the server 108 (step 1114), a market message is displayed (step 1120). When the user is asked a question and the user select an answer, the client 102 makes a network request to the server 108, passing the answer to the question. During this network request, the client 102 can display a market message to the user about what is going on, such as “Posting to server, please wait” or something more informative to the user, such as “Thank you. Sending to server. Your demo will expire in 3 days”. This text is returned to the client 102 in the <Market> tag 152 and displayed to the user in the wireless device application 106 via the GUI 104. Once the network request completes, the user proceeds with the wireless device application 106 (step 1118).

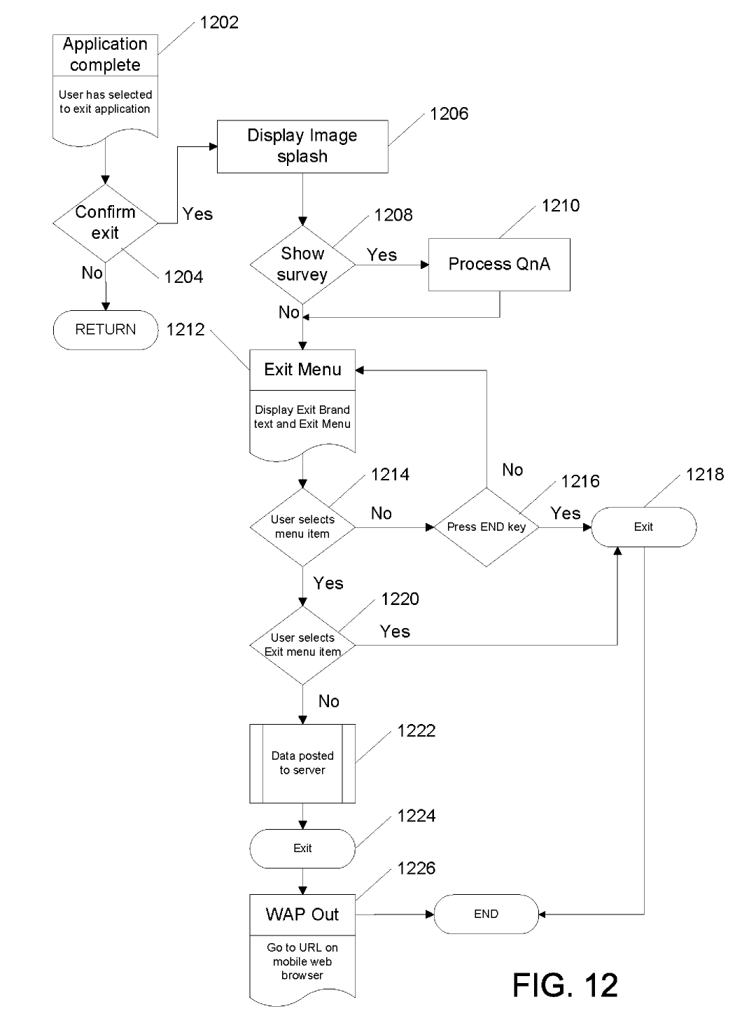

FIG. 12 is a flowchart illustrating in more detail the possible user experience and marketing interactions within the wireless device application after the user has chosen to exit the application as controlled by information received from the server. The user of wireless device application 106 has chosen to exit (step 1202) the wireless device application 106. If the user confirms her wish to exit (step 1204) the wireless device application 106, the wireless device application 106 displays a splash image (step 1206). The splash image can be the same image as an entry image seen on wireless devices today, but can be a separate image. When the user starts the application 106, the user is shown the splash image. When the user exits the application 106, the user may be shown the splash image again prior to the client exit menu being shown via the GUI 104.

After displaying the splash image, the wireless device application 106 checks the information returned by the server 108 if a question/answer survey (step 1208) is to be displayed. If a survey is to be displayed, the question/answer survey is displayed in the wireless device application 106 via the GUI 104, and the answers are processed (step 1210). Once the survey is complete, or if no survey is displayed, the exit menu (step 1212) is displayed in the wireless device application 106 via the GUI 104. The wireless device application 106 checks if a menu item is selected by the user (step 1214). If no menu item is selected and the END key is pressed (step 1216), the wireless device application 106 exits (step 1218). If the user selects a menu item (step 1214), and the menu item selected is the “Exit” menu item (step 1220), then the wireless device application 106 exits (step 1218). If the menu item selected is not the “Exit” menu item (step 1220), the wireless device application 106 initiates a network request and post data to the server 108 (step 1222). The wireless device application 106 then exits (step 1224) and the user is taken to a URL (step 1226) via the wireless device 102 mobile web browser.

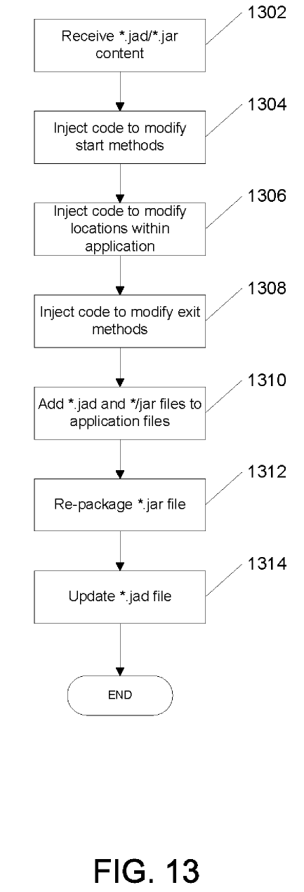

FIG. 13 is a flowchart illustrating in more detail the injection of the client software into an existing application. In the present embodiment, the application is a Java application. The wireless device application 106 is received (step 1302) and comprised of two files (*.jad and *jar). The byte code injection process executes on the server 108. The wireless device application 106 is instrumented to have its start methods modified (step 1304), any location within the application modified (step 1306), and its exit method modified (step 1308). The start methods include a Java method called startApp. This method is the first method called by the application 106 at start time. The exit method includes a Java method called destroApp. This is the last method executed prior to the application 106 exiting. Besides startApp and destroyApp, code in the method called notifyDestroyed is modified. The call to notifyDestroyed is replaced with the method exit Game. Other code can also be modified to perform interstitial marketing or in-game advertising. For example, a marker can be set up in the code where a call exists and used later to find the call to replace it. Once modifications have been completed, the *jad and *jar files are added (step 1310) to the wireless device application 106 files and repackaged into the jar file (step 1312). The wireless device application 106 *jad file is then updated (step 1314) to reflect changes to the wireless device application 106.

The following example will provide more details into the server process for campaign management. Campaigns can have multiple elements. These can include full screen images or videos, banners, survey questions, and merchandising components. From a marketing or advertising perspective, these elements can be used for generating customer leads on a CPM (cost per thousand), CPC (cost per click) or CPA (cost per acquisition) basis.

Assume that a user has downloaded onto the wireless device 102 a wireless device application 106 embedded with software for implementing the inventive method and system, described above. Assume also that the wireless device application is a mobile game. Upon launch of the mobile game, a network request is made to the server 108. The network request submits information from the wireless device application 106 to the server 108. When the network request from the wireless device application 106 is received by the server 108, the server 108 parses the information sent in the request, including the HTTP headers that may be present. This information includes information about the wireless device application 106, information about usage of the mobile game, information about the user of the mobile game, information about the wireless device 102, information about the distributor of the mobile game, and information about the current campaign that may be being displayed to the user. This information is used to determine the actual user experience for the remainder of the execution of the application 106 with respect to marketing interactions, i.e., campaign management.

The campaign information passed to the server 108 is used to determine if the campaign currently active on the mobile game is the actual current campaign for the user. Campaigns can function independent of the content they are being displayed in, i.e., a campaign can progress from start to finish and be performed in multiple applications. Thus, since campaigns can be set up to span multiple applications, there is a need to check to see if the currently active campaign on the wireless device 102 is still the current campaign for the user. If the campaign on the mobile game is not the current campaign, then the server 108 will return information pertaining to the current active campaign and transition the wireless device application 106 to this campaign. In the present example, assume that the current active campaign on the device 102 is the same as on the server 108. The server 108 will gather all of the elements of the campaign as it pertains to this user, this mobile game and this particular start of the mobile game.

Campaign lengths can vary. They can be based upon a minimum number of views by a user or a maximum number of views by a user or they can be set by time, e.g., a campaign runs for 30 days. Campaigns that make use of surveys or questions can have lengths such that they finish all of the questions. The flexibility of the solution allows for questions to have varying start times as well as frequency. For example, the campaign could start the first question of the campaign on the 1st start of an application and have subsequent questions occur every 3^{rd} start of an application. One important use of the question element is in the ability of the user to control campaigns which they are presented inside of the wireless device application 106. Thus, users can be given the opportunity to choose which campaign, from multiple campaigns, they would like to participate. For the present example, assume that the campaign has questions associated to it and the questions will start on the first application launch and occur every time an application is launched.

The elements of the campaign that are retrieved and sent back to the wireless device application 106 can include: images, videos, questions and answers, merchandising and other useful links that can be displayed in a menu for selection. The flexibility of the solution allows for control over placement of the question and answer location, i.e., the solution can display the question and answer prior to or after the user finishes playing and exits the mobile game. This dynamic placement capability also pertains to the menu of merchandising and other links. This can occur prior to or after application interaction. In this example, assume that the campaign elements include three merchandising links. Also assume that the question and answer interaction occurs before playing the mobile game, and the merchandising links are displayed in a menu after the user exits the mobile game.

When the mobile game is started on the wireless device 102, the user sees a full screen image of a brand advertiser. The next thing the user sees is a question along with possible answers. Once the user selects an answer, the information is sent to the server 108 and the mobile game starts. When the user exits the mobile game, the user is displayed a full screen image of the brand advertiser and then a menu of merchandising links are displayed.

For all of the foregoing reasons, the Detailed Description is to be regarded as being in all respects exemplary and not restrictive, and the breadth of the invention disclosed herein is to be determined not from the Detailed Description, but rather from the claims as interpreted with the full breadth permitted by the patent laws.

We claim:

1. A method for providing interactive marketing on a wireless mobile device, the device comprising an application, the method comprising:
(a) receiving by a server a first packet from the wireless mobile device, the first packet comprising: a user identifier for a user of the device, an application identifier for the application, and a device identifier for the device;
(b) determining by the server application control information for controlling access to the application by the user;
(c) determining by the server marketing interactions corresponding to the user identifier, the application identifier, and the device identifier according to predetermined rules;
(d) creating by the server a second packet according the determining (b) and the determining (c), the second packet comprising the application control information and the marketing interactions; and
(e) sending the second packet from the server to the device.

2. The method of claim 1, wherein factors in the rules comprise at least one of the following:
branded messages selected or deselected to be associated with the application;
brands selected or deselected by the user;
user targeting based on user information, demographic profiling, geo-targeting content profiling, or user behavior;
a user answer to a previously posted question;
user-centered marketing campaigns that apply across applications on the device; and
up sell or cross-sell of merchandise in exit menus of the application.

3. The method of claim 1, wherein the determining (b) comprises:
accessing by the server a database coupled to the server;
finding a record in the database, the record comprising usage information for the application for the user; and
setting the application control information in the second packet according to the usage information in the record.

4. The method of claim 3, wherein the usage information comprises a usage counter for a number of plays of the application.

5. The method of claim 3, wherein the setting comprises:
determining by the server a status of an application license from the record;
if the status of the application license is an expired state, then returning exit information in the second packet to the device;
if the status of the application license is not the expired state, then determining by the server a status of a user license for the application from the record;
if the status of the user license is the expired state, then returning the exit information in the second packet to the device; and
if the status of the user license is not the expired state, then updating the record.

6. The method of claim 1, wherein the first packet further comprises usage information, wherein the usage information is sent from the device to the server in real time, wherein the server stores the usage information.

7. The method of claim 1, wherein the user identity is common across a plurality of applications on the device, such that marketing campaigns for user identity is synchronized across the plurality of applications.

8. The method of claim 1, wherein the first packet further comprises current campaign information, wherein the determining (c) comprises:
determining by the server if the current campaign information identifies a valid current campaign corresponding to the user identifier, the application identifier, and the device identifier; and
if the current campaign information identifies a valid current campaign, then creating by the server the second packet, the second packet comprising the market interactions for the current campaign.

9. The method of claim 8, wherein the processing further comprises:
if the current campaign information does not identify a valid current campaign, then determining by the server a next campaign corresponding to the user identifier, the application identifier, and the device identifier, and creating the second packet, the second packet comprising an update to the next campaign for the current campaign information stored on the device.

10. The method of claim 1, wherein the marketing interactions further comprises an exit menu, wherein the second packet further comprises at least one of the following:
an ExitFront flag to control when the exit menu is shown;
a Brand tag for controlling a message on the device to be displayed when the exit menu is displayed;
an ExitMenu tag for controlling an order and a number of items to be displayed on the exit menu; and
an item tag for defining a menu label and a menu key for each exit menu item.

11. The method of claim 1, further comprising:
(f) injecting code into the application at the device by the server, wherein when a computer implements the code, the device:
starts the application,
starts a communication session with the server,
prior to a launching of the application for the user, sends the first packet to the server,
receives the second packet from the server, and
launches the application for the user according to the application control information and displays the marketing interactions in the second packet.

12. The method of claim 11, wherein the injecting (f) comprises:
modifying start methods of the application;
modifying exit methods of the application; and
modifying locations within the application.

13. A method for providing interactive marketing on a wireless mobile device, comprising:
(a) starting an application on the wireless mobile device;
(b) starting a communication session between the device and a server;
(c) prior to a launching of the application for a user of the device, sending a first packet from the device to the server, the first packet comprising: a user identifier for the user, an application identifier for the application, and a device identifier for the device;
(d) receiving by the device a second packet from the server, the second packet comprising: application control information for controlling access to the application by the user; and marketing interactions corresponding to the user identifier, the application identifier, and the device identifier according to predetermined rules; and
(e) launching by the device the application for the user according to the application control information and displaying the marketing interactions.

14. The method of claim 13, wherein the launching (e) comprises:
checking by the device if the second packet comprises exit information, the exit information indicating that the status of the application is an expired state; and
if the second packet comprises the exit information, then exiting the application without giving the user access to the application.

15. The method of claim 13, wherein the launching (e) comprises:
determining by the device if the second packet comprises an AskQnA tag for prompting the user to input user information; and
if the second packet comprises the As AnQ tag, then displaying by the device a request to the user to input the user information.

16. The method of claim 13, wherein the launching (e) comprises:
determining by the device if the second packet comprises a Userlnput tag for displaying to the user a menu with one or more selections; and
if the second packet comprises the UserInput tag, then displaying by the device the menu with the one or more selections.

17. The method of claim 13, wherein the launching (e) comprises:
determining by the device if the second packet comprises a QnA tag for displaying a question and a set of possible answers;
if the second packet comprises the QnA tag, then displaying by the device the question and the set of possible answers.

18. A method for providing interactive marketing on a wireless mobile device, comprising:
(a) starting an application on the wireless mobile device;
(b) starting a communication session between the device and a server;
(c) prior to a launching of the application for a user of the device, sending a first packet from the device to the server, the first packet comprising: a user identifier for the user, an application identifier for the application, and a device identifier for the device;
(d) processing the first packet by the server, the processing comprising:
(d1) determining application control information for controlling access to the application by the user,
(d2) determining marketing interactions corresponding to the user identifier, the application identifier, and the device identifier according to predetermined rules, and
(d3) creating by the server a second packet according to the processing, the second packet comprising the application control information and the marketing interactions;
(e) sending the second packet from the server to the device; and
(f) launching by the device the application for the user according to the application control information and displaying the marketing interactions.
